(19) United States
(12) Patent Application Publication
(10) Pub. No.: US 2008/0094331 A1
(43) Pub. Date: Apr. 24, 2008

(54) DRIVING METHOD FOR REDUCING COLOR SHIFT

(75) Inventors: Feng-Shou Lin, Hsinchu (TW); Yu-Yuan Chang, Hsinchu (TW); Kuo-Liang Shen, Hsinchu (TW); Liang-Bin Yu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: AU OPTRONICS CORPORATION, Hsinchu (TW)

(21) Appl. No.: 11/625,348

(22) Filed: Jan. 22, 2007

(30) Foreign Application Priority Data
Oct. 18, 2006 (TW) 95138348

(51) Int. Cl. G09G 3/36

(52) U.S. Cl. 345/88

(57) ABSTRACT

A driving method for reducing the color shift suitable for driving a display panel is disclosed. The display panel includes at least one scan line, at least one data line, and at least one pixel unit electrically connected to the scan line and the data line. The driving method includes the following steps. First, turn on the pixel unit by the scan line during a frame period. Transmit a frame signal to the pixel unit by the data line during the frame period as the pixel unit is turned on. Turn on the pixel unit by the scan line between the present frame period and the next frame period. Transmit a revising signal to the pixel unit by the data line between the present frame period and the next frame period as the pixel unit is turned on, so as to reduce the color shift of the pixel unit.

### CROSS-REFERENCE TO RELATED APPLICATION

This application claims the priority benefit of Taiwan application serial no. 95138348, filed on Oct. 18, 2006. All disclosure of the Taiwan application is incorporated herein by reference.

### BACKGROUND OF THE INVENTION

1. Field of the Invention

The present invention relates to a driving method, and more particularly, to a driving method for reducing the color shift.

2. Description of Related Art

The rapid development of the multimedia society mostly benefits from the rapid progress in developing semiconductor elements or display apparatus. As for the display, the cathode ray tube (CRT) has occupied the top place in the display market in the recent years due to its excellent displaying quality and cost-effectiveness. However, as for the circumstance that a plurality of terminals/display devices is operated by a single person on desk-top, or in consideration of the environmental protection, if predicted from the trend of saving energy, the CRT still has many problems in space utilization and power consumption, which cannot effectively satisfy the requirements of the present trend of being light, thin, short, small and low power consumption. Therefore, thin film transistor liquid crystal displays (TFT-LCD) having excellent properties such as high definition, preferred space utilization, low power consumption and low radiation have gradually become the mainstream of the market.

Generally, the current TFT-LCDs meet the requirements of full color frame, which can not only display black-white frames, but also display various colors. Each TFT-LCD has a plurality of pixels, and the internal circuit of each pixel is shown in FIG. 1.

FIG. 1 is a circuit diagram of an internal circuit of a pixel. Referring to FIG. 1, the pixel 110 includes a red pixel unit 120, a green pixel unit 130, and a blue pixel unit 140. Just as the name implies, the red pixel unit 120 is used to display the red light, the green pixel unit 130 is used to display the green light, and the blue pixel unit 140 is used to display the blue light. The red pixel unit 120 includes a thin film transistor 121 and a red liquid crystal capacitor 122, the green pixel unit 130 includes a thin film transistor 131 and a green liquid crystal capacitor 132, and the blue pixel unit 140 includes a thin film transistor 141 and a blue liquid crystal capacitor 142. Vcom indicates a common potential. The pixel units of each color are all coupled to a scan line, and the pixel units of each color are also coupled to a data line 1, a data line 2 and a data line 3 respectively. The driving method of the pixel unit is illustrated below with reference to FIG. 2.

FIG. 2 is a signal timing diagram of driving the pixel unit with the conventional driving method. In order to facilitate the illustration, the signal timing of the red pixel unit 120 is taken as an example first, with reference to FIG. 2 and FIG. 1 as the illustration requires. In FIG. 2, 100 denotes a signal on the scan line, 200 denotes a signal on the data line 1, D1 denotes a first data voltage provided by the data line 1 to the red pixel unit 120 for being displayed, D2 denotes a data voltage provided by the data line 1 to the red pixel unit 120 for being displayed in the next frame, and the polarities of the data voltages D1 and D2 are opposite, so as to make the liquid crystals rotate in positive and negative directions respectively, thus preventing the liquid crystals from being polarized. G1 denotes an enable signal transmitted by the scan line for turning on the thin film transistor 121, when the red pixel unit 120 needs to display a first data; and G2 denotes an enable signal transmitted by the scan line for turning on the thin film transistor 121, when the next frame is to be displayed.

When the scan line outputs the enable signal G1, thereby turning on the thin film transistor 121 of the red pixel unit 120, the data line 1 also outputs a data voltage D1 with a level, so as to charge the liquid crystal capacitor 122 via the thin film transistor 121, such that the red pixel unit 120 displays a red light with a certain intensity. When the scan line outputs the enable signal G2, thereby turning on the thin film transistor 121 in the red pixel unit 120, the data line 1 also outputs a data voltage D2 with a level, so as to charge the liquid crystal capacitor by the thin film transistor 121, such that the red pixel unit 120 displays a red light with the same intensity. Accordingly, the green pixel unit 130 and the red pixel unit 120 are driven by the same manner, and then, the displaying purpose of the pixel 110 is achieved by mixing the three colors, red, green, and blue, and then a frame is presented by a plurality of pixels.

As for displaying a white frame, it is displayed by mixing the red light, green light and blue light into a white light, and the gray level of the white light is changed with the changing of the gray levels of the red light, green light and blue light. For example, the white light of 32 gray levels is mixed by the red light, the green light and the blue light of 32 gray levels each. In addition, according to the color reproducibility specification made by the national television system committee (NTSC), the white light obtained by mixing the red light, the green light and the blue light in a specific proportion corresponds to a specific color temperature.

FIG. 3 is a gray level to color temperature relation curve of white frames displayed by a conventional thin film transistor liquid crystal display, and FIG. 4 lists the color temperatures corresponding to the white lights of different gray levels in FIG. 3. In FIG. 3, the curve 10 is a gray level to color temperature relation curve before adjusting the mixing proportion of the red light, the green light or the blue light, and the curve 20 is a gray level to color temperature relation curve after adjusting the mixing proportion of the red light, the green light or the blue light. FIG. 4 lists the values of gray levels and color temperatures of the curve 10 and the curve 20 in FIG. 3. Referring to FIG. 3 and FIG. 4, it can be seen from the curve 10 in FIG. 3 and the values listed in FIG. 4 that, when the conventional thin film transistor liquid crystal display displays a white frame, the white lights of different gray levels mixed by red light, green light and blue light correspond to different color temperatures. However, the difference between color temperatures corresponding to white lights of different gray levels is significant, thus causing abnormality in the sense of the human eyes, for example, a particular frame is relatively red or relatively blue. Thus, the color shift occurs for the conventional thin film transistor liquid crystal display, causing undesired displaying quality.

In order to resolve the problem, another method is known in the art, which mixes white lights of different gray levels by appropriately reducing the mixing proportion of the red light, the green light or the blue light. As for the white light having a higher color temperature before adjustment, the color temperature is reduced by appropriately reducing the mixing proportion of the blue light. As for the white light having a low color temperature before adjustment, the color temperature is increased by appropriately reducing the mixing proportion of the red light. Referring to FIG. 3 and FIG. 4, it can be seen from the curve 20 in FIG. 3 and the values after adjustment in FIG. 4 that, after appropriately reducing the mixing proportion of the red light, the green light or the blue light, the color temperatures corresponding to white lights of different gray levels are approximate to each other. However, after the whole intensity reduces to a certain constant value, this method of adjusting the color temperature by subtraction principle cannot be applied any more. In other words, the color temperature of the white light of lower gray level is still high, and the color shift still exists.

### SUMMARY OF THE INVENTION

In view of the above, the present invention is directed to a driving method for reducing the color shift.

In order to achieve the above or another objective, the present invention provides a driving method for reducing the color shift, which is suitable for driving a display panel. The display panel comprises at least one scan line, at least one data line and at least one pixel unit electrically connected to the scan line and the data line. The driving method comprises: turning on the pixel unit by the scan line during a frame period; transmitting a frame signal to the pixel unit by the data line during the frame period as the pixel unit is turned on; turning on the pixel unit by the scan line between the present frame period and the next frame period; and transmitting a revising signal to the pixel unit by the data line between the present frame period and the next frame period as the pixel unit is turned on, so as to reduce the color shift of the pixel unit.

In an embodiment of the present invention, each of the frame signal and the revising signal comprise at least one of a red signal, a green signal, and a blue signal.

In an embodiment of the present invention, the values of the red signal, the green signal and the blue signal of the revising signal are different from each other.

In an embodiment of the present invention, a vertical blank period exist between the present frame period and the next frame period, and the revising signal is transmitted to the pixel unit during the vertical blank period, so as to reduce the color shift of the pixel unit.

In an embodiment of the present invention, during any two adjacent frame periods, the voltage polarities of the frame signal are opposite.

In an embodiment of the present invention, during any two adjacent frame periods, the voltage polarities of the revising signal are opposite.

In an embodiment of the present invention, the duration of transmitting the frame signal to the pixel unit is different from that of transmitting the revising signal to the pixel unit.

In an embodiment of the present invention, the display panel comprises a liquid crystal display panel.

In an embodiment of the present invention, the colors displayed by the pixel unit include red, green or blue.

In an embodiment of the present invention, the display panel employs a normally black display mode, and the voltage of the revising signal is smaller than that of the frame signal.

In an embodiment of the present invention, the display panel employs a normally white display mode, and the voltage of the revising signal is larger than that of the frame signal.

In the driving method provided by the present invention, the pixel unit is turned on for at least twice during each frame period, wherein the frame signal is transmitted to the pixel unit as the pixel unit is turned on for the first time, and the revising signal is transmitted to the pixel unit as the pixel unit is turned on at another time. The voltage of the revising signal is different from that of the frame signal, therefore, during the same frame period, the pixel unit correspondingly displays a different color intensity each time when it is turned on. If one or more than two of the pixel units correspondingly displaying the red light, the green light and the blue light are driven by this driving method, the color temperature of the white light of each gray level may be modulated. In other words, by driving a display panel using this driving method, the color shift of the display panel may be reduced to enhance the display quality of the display panel.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of an internal circuit of a pixel.

FIG. 2 is a signal timing diagram of driving the pixel unit with a conventional driving method.

FIG. 3 is a gray level to color temperature relation curve of white frames displayed by a conventional thin film transistor liquid crystal display.

FIG. 4 lists color temperatures corresponding to the white lights of different gray levels in FIG. 3.

FIG. 5 is a signal timing diagram of a driving method for reducing the color shift according to an embodiment of the present invention.

FIG. 6 is a flow chart of the driving method for reducing the color shift according to an embodiment of the present invention.

FIG. 7 is a signal timing diagram of the driving method for reducing the color shift according to another embodiment of the present invention.

FIG. 8 is a signal timing diagram of the pixel unit without requiring the color compensation.

FIG. 9 is a gray level to color temperature relation curve of white frames displayed by a display panel driven by the driving method of the present invention.

FIG. 10 lists color temperatures corresponding to the white lights of different gray levels in FIG. 9.

FIG. 11 is a gray level to color temperature relation curve of white frames displayed by another display panel driven by the driving method of the present invention.

FIG. 12 is a gray-scale to intensity relation curve for the three colors of red, green, and blue.

FIG. 13 shows a shift degree of a white frame under different gray levels.

### DESCRIPTION OF EMBODIMENTS

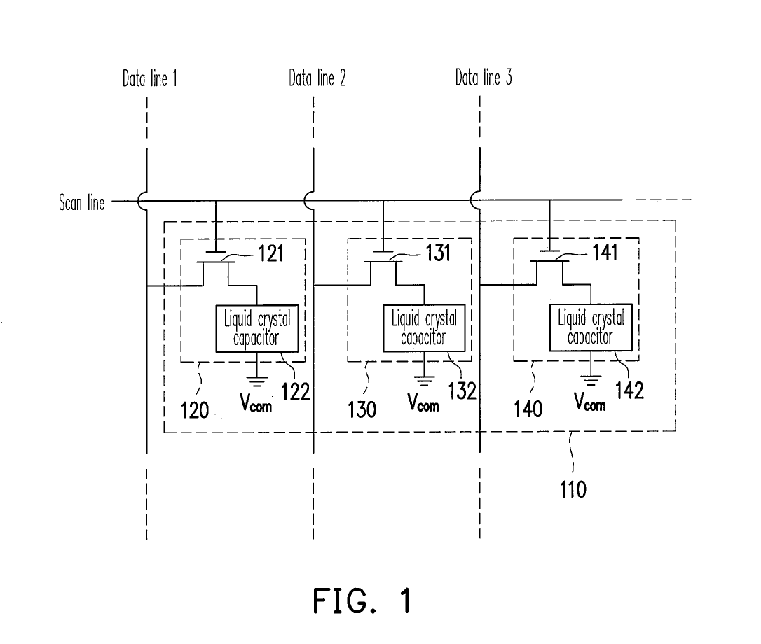

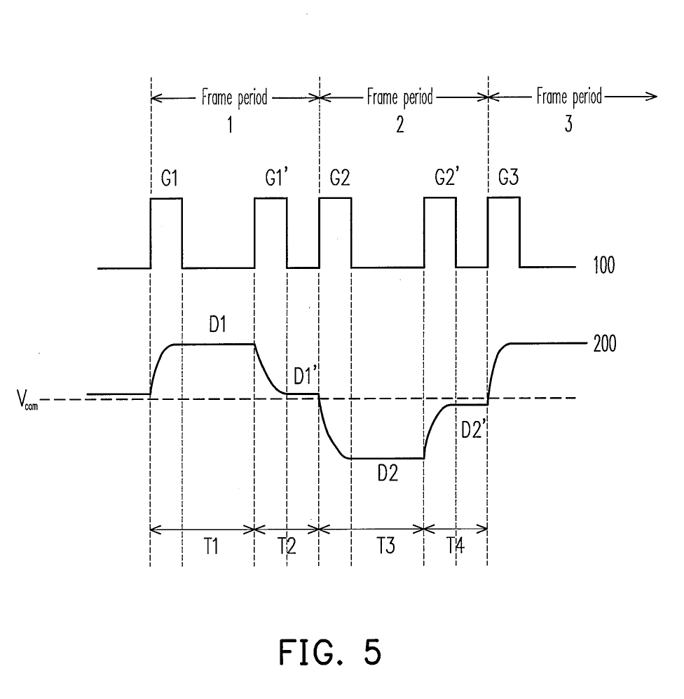

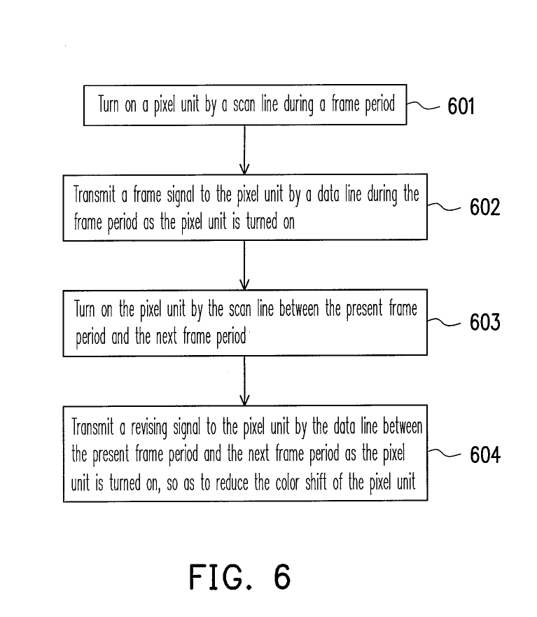

FIG. 5 is a signal timing diagram of a driving method for reducing the color shift according to an embodiment of the present invention. FIG. 6 is a flow chart of the driving method for reducing the color shift according to an embodiment of the present invention. In order to facilitate the illustration, the circuit shown in FIG. 1 is taken as an example in the following embodiments, and it is assumed the display panel used for implementing the driving method of the present invention employs a normally black display mode.

Referring to FIGS. 1, 5 and 6, for revising the color displayed by a red pixel unit 120, during a frame period, e.g., a frame period 1 shown in FIG. 5, an enable signal G1 is transmitted by a scan line, so as to turn on the red pixel unit 120 (as shown in Step 601 in FIG. 6). A data voltage D1 with a level is output by a data line 1 during the frame period 1 as the red pixel unit 120 is turned on, thereby charging a liquid crystal capacitor 122 by a thin film transistor 121, which may be considered as transmitting the frame signal, i.e., a red signal, to the red pixel unit 120, as shown in Step 602 in FIG. 6, and similarly, it may be considered as transmitting a green signal to a green pixel unit 130, and transmitting a blue signal to a blue pixel unit 140. Therefore, during the time period T1, the red pixel unit 120 correspondingly displays red with a certain intensity.

Next, an enable signal G1′ is transmitted by the scan line between the frame period 1 (i.e., the present frame period) and a frame period 2 (i.e., the next frame period), so as to turn on the red pixel unit 120 once again (as shown in Step 603 in FIG. 6). A data voltage D1 with a level is output by the data line 1 between the frame period 1 and the frame period 2 as the red pixel unit 120 is turned on, thereby charging the liquid crystal capacitor 122 by the thin film transistor 121, which may be considered as transmitting the revising signal, i.e., a red signal for revising, to the red pixel unit 120, as shown in Step 604 in FIG. 6, and similarly, it may be considered as transmitting a green signal for revising to the green pixel unit 130, and transmitting a blue signal for revising to the blue pixel unit 140. Therefore, during the time period of T2, the red pixel unit 120 correspondingly displays red with another intensity.

Similarly, an enable signal G2 is transmitted by the scan line during the frame period 2, so as to turn on the red pixel unit 120. A data voltage D2 with a level is output by the data line 1 during the frame period 2 as the red pixel unit 120 is turned on, thereby charging the liquid crystal capacitor 122 by the thin film transistor 121, therefore, during the time period of T3, the red pixel unit 120 correspondingly displays red with a certain intensity. However, the value of the data voltage D2 is the same as that of the data voltage D1, but their polarities are opposite to each other, therefore, the displaying intensities of the red pixel unit 120 are the same during the time periods T3 and T1.

Next, an enable signal G2′ is transmitted by the scan line between the frame period 2 (i.e., the present frame period) and a frame period 3 (i.e., the next frame period), so as to turn on the red pixel unit 120 once again. A data voltage D2′ with a level is output by the data line 1 between the frame period 2 and the frame period 3 as the red pixel unit 120 is turned on, thereby charging the liquid crystal capacitor 122 by the thin film transistor 121, therefore, during the time period of T4, the red pixel unit 120 correspondingly displays red with an another intensity. However, the value of the data voltage D2′ is the same as that of the data voltage D1′, but their polarities are opposite to each other, therefore, the displaying intensities of the red pixel unit 120 are the same during the time periods T4 and T2. The situation during other frame periods may be derived through the similar method, which thus will not be described herein.

In other words, as the data voltage D1 and the data voltage D1′ are different, during the frame period 1, the red pixel unit 120 displays two different in depth types of the same color, so as to be mixed into a new color depth. Likewise, as the data voltage D2 and the data voltage D2′ are different, during the frame period 2, the red pixel unit 120 also displays two different in depth types of the same color, so as to be mixed into a new color depth. However, the new colors mixed during the frame period 1 and the frame period 2 are the same. In such a manner, the newly mixed red light is used to match with the green light displayed by the green pixel unit 130 and the blue light displayed by the blue pixel unit 140, thereby reducing the color shift.

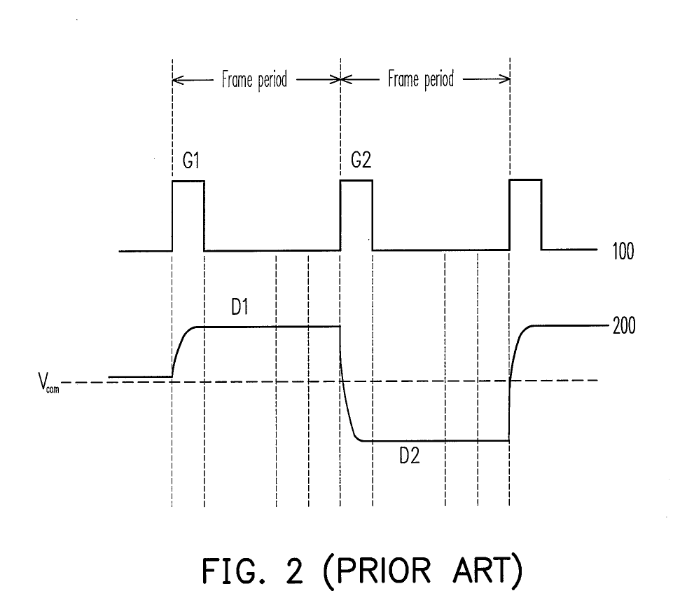

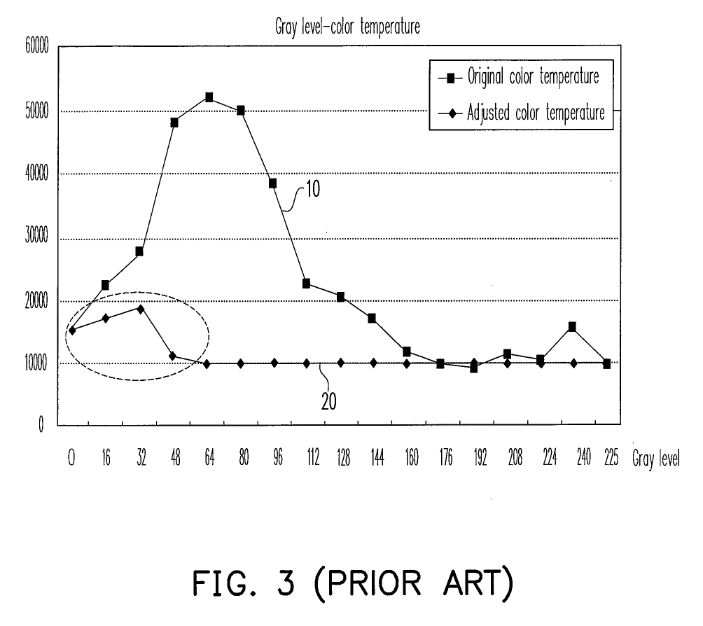

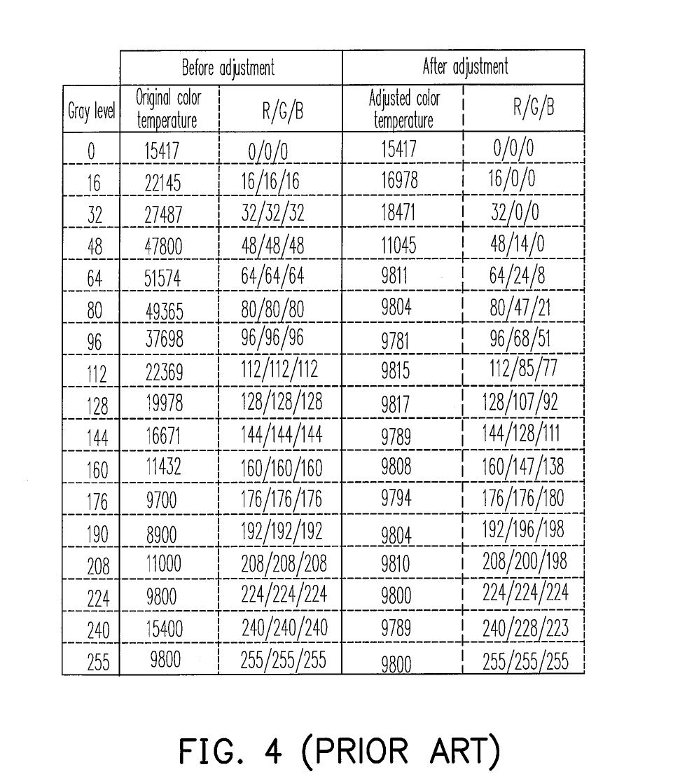

To distinguish this driving method from the conventional method shown in FIG. 2, briefly, only one enable signal (e.g., G1 and G2) exists during each frame period in the conventional method, whereas this driving method adds the number of the enable signal during each frame period. As for this embodiment, an enable signal G1′ is added after the enable signal G1, and an enable signal G2′ is added after the enable signal G2. In this driving method, the voltage value of the data line 1 is changed while adding the enable signals G1′ and G2′, thereby changing the color displayed by the red pixel unit 120. Of course, the high-level user not only changes the value of the data voltage, but also changes the time for adding the enable signal G1′ and the enable signal G2′, i.e., changing the durations T2 and T4, so as to perform finer color control.

By driving one or more than one of the pixel units for displaying the red light, the green light and the blue light through the above driving method, the white light of each gray level may correspond to a similar color temperature. Furthermore, the values of at least two of the red signal, the green signal and the blue signal of the revising signal are different from each other, or the three values are all different. As for the timing for transmitting the revising signal, the revising signal is transmitted in a vertical blank period (VBP) between two frame periods, or transmitted between two enable signals respectively transmitted by two adjacent scan lines.

Moreover, the display panel may be a liquid crystal display panel or another suitable display panel, and this driving method can not only be applied to a display panel employing the normally black display mode, but also can be applied to a display panel employing the normally white display mode, but the operating manners for the above two circumstances are opposite. For example, if this driving method is applied to the display panel employing the normally black display mode, the voltage of the revising signal is less than that of the frame signal. On the contrary, if this driving method is applied to the display panel employing the normally white display mode, the voltage of the revising signal is larger than that of the frame signal.

A practical application is taken as an example below to make one skilled in the art to understand the present invention. Referring to FIGS. 1 and 5, the frame period 1 of FIG. 5 is taken as an example. When the color temperature of the displayed frame is high, during the time period T1 where the frame is displayed normally, the data lines 1, 2, and 3 all output a data voltage D1 with a level. The data voltage D1 is a normally displayed voltage signal, that is, the voltage levels of the red, green and blue signals respectively received by the red pixel unit 120, the green pixel unit 130 and the blue pixel unit 140 are the voltage levels of the frame image to be displayed.

Therefore, color compensation may be performed for the red signal at the time T2 during the frame period 1, and the voltage level of the data voltage D1′ added at this time is a low-level voltage (when the display panel employs the normally black display mode) or a high-level voltage (when the display panel employs the normally white display mode) corresponding to data voltage D1. The green and blue signals are not compensated, and the voltage level of the data voltages thereof are zero-level voltage (when the display panel employs the normally black display mode) or highest-level voltage (when the display panel employs the normally white display mode). The so-called highest-level voltage is the 64th-level voltage as for a six-bit display, and it is the 255th-level voltage as for an eight-bit display.

It should be noted that, when the user receives a white frame having a higher color temperature and a red frame in a short time, due to the integral effect of human eyes, the user will sense a white light having an intermediate color temperature. With this principle, the white light of each gray level may be modulated to correspond to the desired color temperature. When the white lights of each gray level correspond to a similar color temperature, the user will not view a relatively red or relatively blue frame, thus the displaying quality of the display panel is significantly enhanced.

Of course, besides driving the red pixel unit 120 with the above driving method, the red pixel unit 120 and the green pixel unit 130 also may be driven with the above driving method, and a zero-level voltage is added to the blue pixel unit 140 at the time T2 during the frame period 1 and at the time T4 during the frame period 2. Similarly, as for the gray level with a relatively low color temperature, only the blue pixel unit 140 is driven by the above driving method, and a zero-level voltage is added to the red pixel unit 120 and the green pixel unit 130 at the time T2 during the frame period 1 and at the time T4 during the frame period 2. The principle thereof is similar to that described above, which thus will not be described herein.

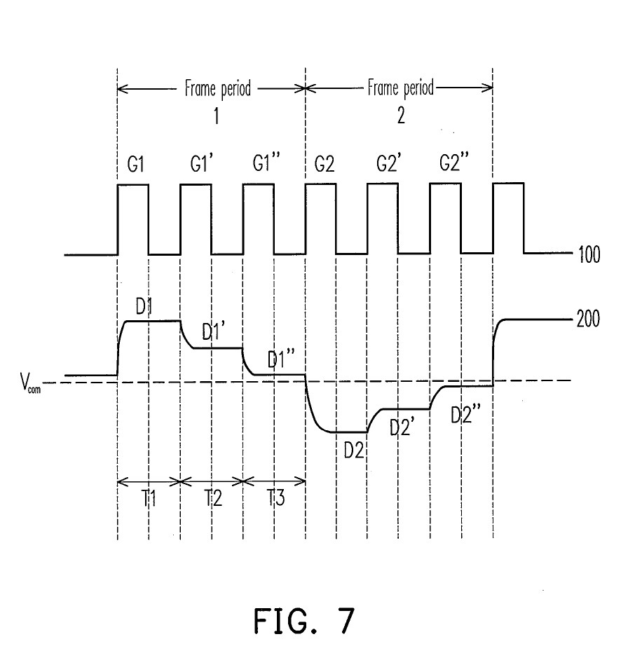

Although several possible implementations of the driving method in the present invention have been described in the above embodiments, those of ordinary skill in the art should know that, the driving method of the present invention still has other implementation methods, and the driving method of the present invention is not limited to the above mentioned implementations. In other words, it meets the spirit of the present invention, as long as the number of enable signals is increased during the same frame period to turn on the pixel unit for several times, and as the pixel unit is turned on, revising signals with different voltage values are transmitted to the pixel unit, so as to reduce the color shift. Another possible implementation is simply illustrated below, as shown in FIG. 7.

FIG. 7 is a signal timing diagram of a driving method for reducing the color shift according to another embodiment of the present invention. Referring to FIG. 5 and FIG. 7 as the illustration requires, the difference between FIG. 7 and FIG. 5 lies in that, in FIG. 7, one enable signal is further added during each frame period, e.g., an enable signal G1″ is further added during the frame period 1, and the revising signal also presents a level of D1, D1′, and D1′ as for the enable signals G1, G1′, and G1″. It can be known from FIG. 7 that, the user may increase the number of the enable signals, and the type of the levels of the revising signal, so as to more finely control the color displayed by the pixel unit.

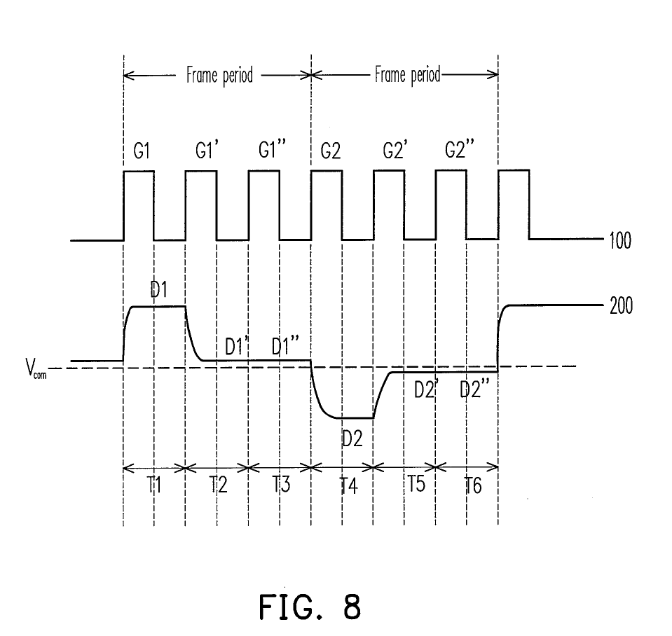

FIG. 8 shows a signal timing diagram of the pixel unit that requires the color compensation. However, the signal timings of the pixel units without requiring the color compensation are shown in FIG. 8. FIG. 8 is a signal timing diagram of the pixel unit without requiring the color compensation. It can be seen from FIG. 8 that, during the time T2 and T3, the levels of the revising signals D1′ and D1″ are the same, i.e., O-level voltage. Furthermore, during the time T5 and T6, the levels of the revising signals D2′ and D2″ are the same as well, i.e., O-level voltage.

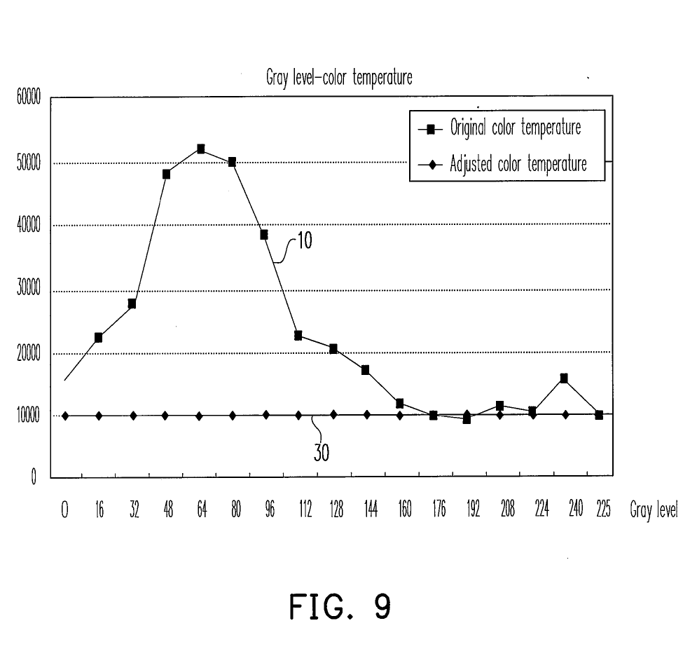

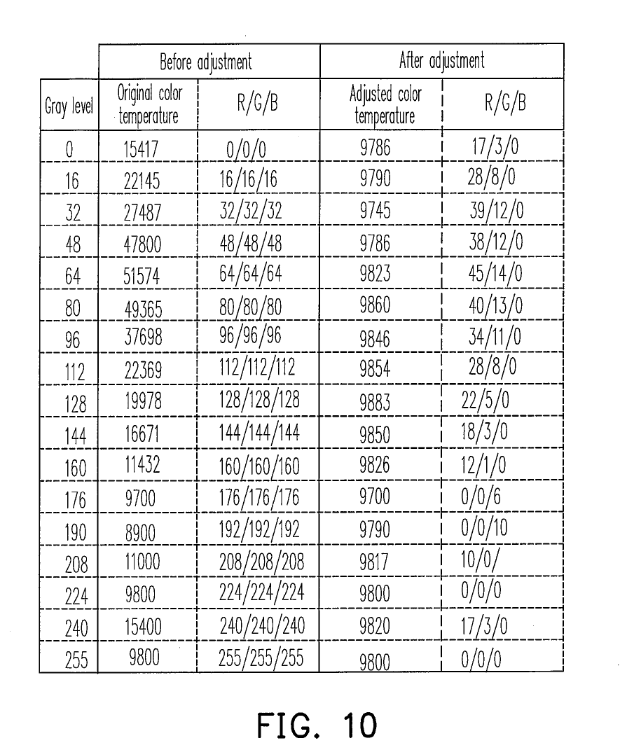

FIG. 9 is a gray level to color temperature relation curve of white frames displayed by a display panel driven by the driving method of the present invention, and FIG. 10 lists color temperatures corresponding to white lights of different gray levels in FIG. 9. In FIG. 9, the curve 10 is a conventional gray level to color temperature relation curve before adjusting the mixing proportion of the red light, the green light or the blue light, and the curve 30 is a gray level to color temperature relation curve of a white light modulated by the driving method of the present invention. FIG. 10 lists the values of gray levels and color temperatures of the curves 10, 30 in FIG. 9. Referring to FIG. 9 and FIG. 10, it can be seen from the figures that, after the color temperature of the white light of each gray level is modulated by the driving method provided in the present invention, the white light of each gray level corresponds to a similar color temperature. Therefore, by driving a display panel using the driving method of the present invention, the color shift of the display panel may be reduced to enhance the display quality of the display panel.

In addition, the revising signal has a voltage level that is different from that of the frame signal, such that the displayed frame is similar to a dark frame, thus, the frame displaying manner is similar to the pulse type of the conventional CRT. In such a manner, the user is not easy to observe the motion blur, that is, more preferable displaying quality can be achieved by driving the display panel with the driving method of the present invention.

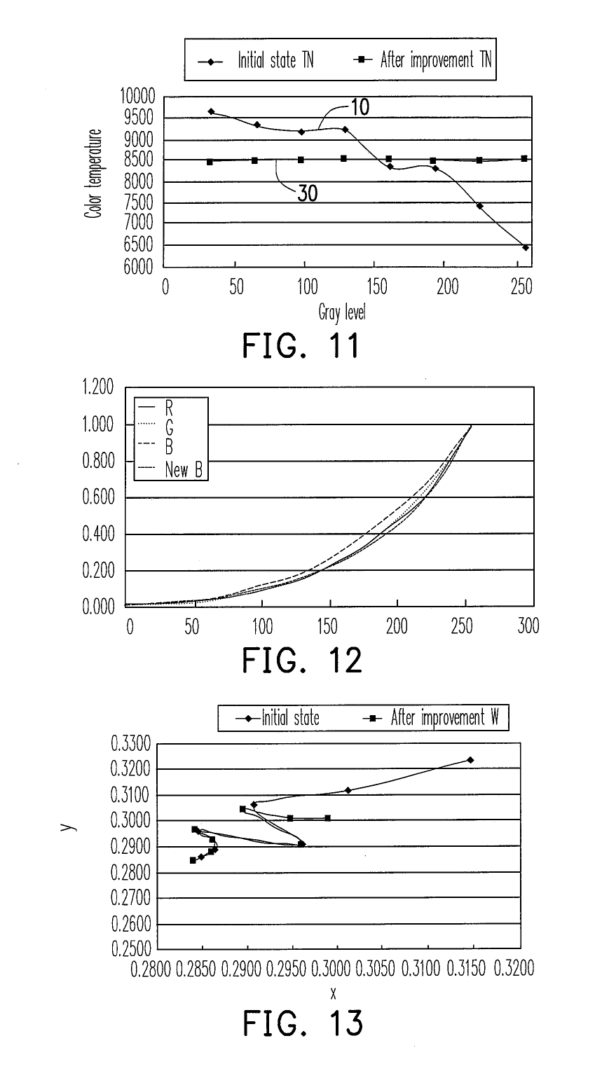

The above description is on the basis of taking dark frame as the low voltage, but when the dark frame is a high voltage, the principle is also the same, with the exception that the compensation voltage value must be changed, which is illustrated with reference to FIGS. 11, 12, and 13. FIG. 11 is a gray level to color temperature relation curve of white frames displayed by another display panel driven by the driving method of the present invention. FIG. 12 is a gray-scale to intensity relation curve for the three colors of red, green, and blue. FIG. 13 shows a shift degree of a white frame of different gray levels. Refer to FIGS. 11, 12, and 13 as the illustration requires.

Referring to FIG. 11 first, as shown by the curve 10, the initial color temperature presents an unstable state, under the simulation circumstance without requiring any color compensation. After adding a revising signal through the same processing method as that mentioned above, the color temperature curve presents a stable state, as shown by the curve 30. The gray-scale to intensity curves for the three colors of red, green, and blue are shown in FIG. 12. In the initial state, the blue characteristic curve is not consistent with the red and green characteristic curves, however, after adding the revising signal, the blue characteristic curve drops, and tends to be consistent with the red and green characteristic curves. Furthermore, the x and y shift degrees of the white frame of different gray levels can be seen from FIG. 13, and when the (x, y) coordinate values has larger shift as the gray level is changed, the frame color performance thereof has shifts as well, however, after adding the revising signal for reducing the shift, the shifts of (x, y) values in different gray-levels are significantly reduced. Therefore, the processing method can be implemented regardless of whether a low voltage is a dark frame or a high voltage is a dark frame.

In view of the above, the driving method provided by the present invention at least has the following advantages.

First, in the driving method provided by the present invention, the revising signals transmitted to the pixel unit during each frame period has different voltage levels, such that the pixel unit correspondingly displays a color of different gray levels but of the same color, each time when it is turned on. If one or more than two of the pixel units for displaying the red light, the green light and the blue light are driven by this driving method, the color temperature corresponding to the white light of each gray level may be modulated. Therefore, by driving a display panel using this driving method, the color shift of the display panel is reduced to enhance the display quality of the display panel.

Secondly, the revising signal added during each frame period has a voltage level of dark display, such that the frame displaying manner is similar to the pulse type of the conventional CRT, therefore, the user is not easy to observe the motion blur, that is, the displaying quality of the display panel is enhanced by driving the display panel using the driving method of the present invention.

In addition, the present invention is different from the gray-frame insertion technique (i.e., inserting a “gray” frame). In terms of the definition, the definition of gray is different from the definitions of red, blue, green, yellow, magenta, and cyan. Moreover, the so-called gray frame is purely defined with 0-255 levels (8 bits), that is, the values of RGB are (0, 0, 0), (1, 1, 1), . . . , (254, 254, 254), or (255, 255, 255); however, as for the inserted frame in the present invention, there are various possibilities for the values of RGB, such as (1, 3, 0), (0, 2, 0), (16, 0, 0), or (0, 0, 8) . . . .

Furthermore, in the present invention, different pixels are compensated after determining with data, that is, the compensation data of the present invention is used to perform compensation on the basis of previous display frames, therefore, the compensations of the intensity, color, time and determining manner of each pixel are different. If one's eyes are sharp enough to watch the compensation frames, the presented colors are irregular, and the intensity thereof is not so high. To sum up, the present invention and the gray-frame insertion technique are two different techniques.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving method for reducing the color shift, suitable for driving a display panel, wherein the display panel comprises at least one scan line, at least one data line and at least one pixel unit electrically connected to the scan line and the data line, the driving method comprising:
turning on the pixel unit by the scan line during a frame period;
transmitting a frame signal to the pixel unit by the data line during the frame period as the pixel unit is turned on;
turning on the pixel unit by the scan line between the frame period and a next frame period; and
transmitting a revising signal to the pixel unit by the data line between the frame period and the next frame period as the pixel unit is turned on.

2. The driving method of claim 1, wherein the frame signal and the revising signal respectively comprise at least one of a red signal, a green signal and a blue signal.

3. The driving method of claim 2, wherein values of the red signal, the green signal and the blue signal of the revising signal are different from each other.

4. The driving method of claim 1, wherein there is a vertical blank period between the present frame period and the next frame period, and the revising signal is transmitted to the pixel unit during the vertical blank period, so as to reduce the color shift of the pixel unit.

5. The driving method of claim 1, wherein during any two adjacent frame periods, voltage polarities of the frame signal are opposite.

6. The driving method of claim 5, wherein during any two adjacent frame periods, voltage polarities of the revising signal are opposite.

7. The driving method of claim 1, wherein a duration of transmitting the frame signal to the pixel unit is different from that of transmitting the revising signal to the pixel unit.

8. The driving method of claim 1, wherein the display panel comprises a liquid crystal display panel.

9. The driving method of claim 1, wherein the color displayed by the pixel unit comprises red, green or blue.

10. The driving method of claim 1, wherein the display panel employs a normally black display mode.

11. The driving method of claim 10, wherein the voltage of the revising signal is less than that of the frame signal.

12. The driving method of claim 1, wherein the display panel employs a normally white display mode.

13. The driving method of claim 12, wherein a voltage of the revising signal is larger than that of the frame signal.
